(19) United States
(12) Patent Application Publication
(10) Pub. No.: US 2003/0155347 A1
(43) Pub. Date: Aug. 21, 2003

(54) Carbon fiber-embedded heating paper and thereof sheet heater

(76) Inventors: Tae-Sung Oh, Seoul (KR); Young-Suk Shu, Kyoungki-do (KR)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/333,911

(22) PCT Filed: May 25, 2001
(86) PCT No.: PCT/KR01/00873

(30) Foreign Application Priority Data
Aug. 26, 2000 (KR) 200049897

(51) Int. Cl. H05B 3/54

(52) U.S. Cl. 219/545; 219/549

(57) ABSTRACT

This invention is related to the carbon fiber-embedded heating paper and thereof sheet heater. The alignment of the carbon fibers is controlled to give different heating characteristics to lateral and transverse directions of the said heating paper, which improves a variety of adaptabilities by using the said heating paper. The present invention is to provide the heating paper where the pulp is fabricated in the carbon fiber to have heating characteristics to lateral and transverse directions and the sheet heater comprised of the polymer coating to have electrically insulating characteristics. A variety of characteristics can be obtained from the sheet heater in case of need.

### BACKGROUND OF THE INVENTION

1. Field of the Invention

This invention relates to a heating paper and thereof sheet heater, and more particularly to a carbon fiber-embedded heating paper and thereof sheet heater.

2. Description of the Prior Art

As sheet heaters utilize the electricity, it is easy to control the temperature of the sheet heaters without contaminating the air and making any noise. Thus, sheet heaters are widely applied to heating mats and heating pads, heating quilts, heating mattresses, heating blankets, and heating systems for houses and apartments. Also, sheet heaters are widely used for the heating systems of the commercial, industrial, public, military, agricultural facilities. In addition, sheet heaters are utilized to various applications including, but not limited to, the commercial and household heating and drying systems, anti-freezing and snow-melting systems for roads and parking lots, heating-capable products for leisure and cold protection, anti-fogging systems for mirrors and window glasses, and health-aid systems, etc.

Resistive heating wires such as nichrome wire are typically used for the sheet heaters. However, the sheet heaters using resistive heating wires have major problem of reliability as all the current is usually carried by a single continuous wire. A break anywhere of the whole resistive heating wire makes the entire sheet heater inoperable. Also, the heating wire should be surrounded by electrical insulator to prevent short-circuit. As electrical insulator is also thermal insulator in common, however, the heating efficiency of the sheet heater using resistive heating wire is lowered substantially with electrical insulation treatment.

In addition, the temperature distribution on the sheet heater with resistive heating wire is not uniform, as heating in the said sheet heater is localized near the heating wire. Also, the sheet heater utilizing resistive heating wire such as nichrome are not suitable for radiation heating, as metals have low emissivities of far-infrared radiation and have low efficiencies to convert electrical energy into radiant heat.

### SUMMARY OF THE INVENTION

This invention is related to the carbon fiber-embedded heating paper in which the alignment of the carbon fibers is controlled to give different heating characteristics to lateral and transverse directions of the said heating paper so that sheet heaters with different heating characteristics can be accomplished with the same heating paper. This invention is also related to a sheet heater composed of a carbon fiber-embedded heating paper in which heat-conducting ceramic fibers, powders or their mixture are dispersed to improve the heating characteristics and reliability of the sheet heater. This invention is also related to a sheet heater composed of the said carbon fiber-embedded heating papers, for which heat-conducting ceramic fibers, powders, or their mixture are dispersed in the polymer coatings laminated on the said heating paper to improve the heating efficiency and long-term reliability of the sheet heater.

### BRIEF DESCRIPTION OF THE DRAWINGS

FIG. 1 is the plan view of the carbon fiber-embedded heating paper.

FIG. 2 is the cross-sectional view of the carbon fiber-embedded heating paper shown in FIG. 1.

FIG. 3 is the plan view of the carbon fiber-embedded heating paper with electrodes installed in the lateral edges of the heating paper.

FIG. 4 is the plan view of the carbon fiber-embedded heating paper with electrodes installed in the transverse edges of the heating paper.

FIG. 5 is the plan view of the carbon fiber-embedded heating paper where ceramic fibers are dispersed with carbon fibers.

FIG. 6 is the cross-sectional view of the carbon fiber-embedded heating paper shown in FIG. 5.

FIG. 7 is the plan view of the carbon fiber-embedded heating paper where ceramic powders are dispersed with carbon fibers.

FIG. 8 is the cross-sectional view of the carbon fiber-embedded heating paper shown in FIG. 7.

FIG. 9 is the schematic of the sheet heater fabricated using the carbon fiber-embedded heating paper.

FIG. 10 is the cross-sectional view of the sheet heater shown in FIG. 9.

FIG. 11 is the cross-sectional view of the sheet heater for which ceramic fibers are dispersed in the polymer coatings.

FIG. 12 is the cross-sectional view of the sheet heater for which ceramic powders are dispersed in the polymer coatings.

### DESCRIPTION OF PREFERRED EMBODIMENTS

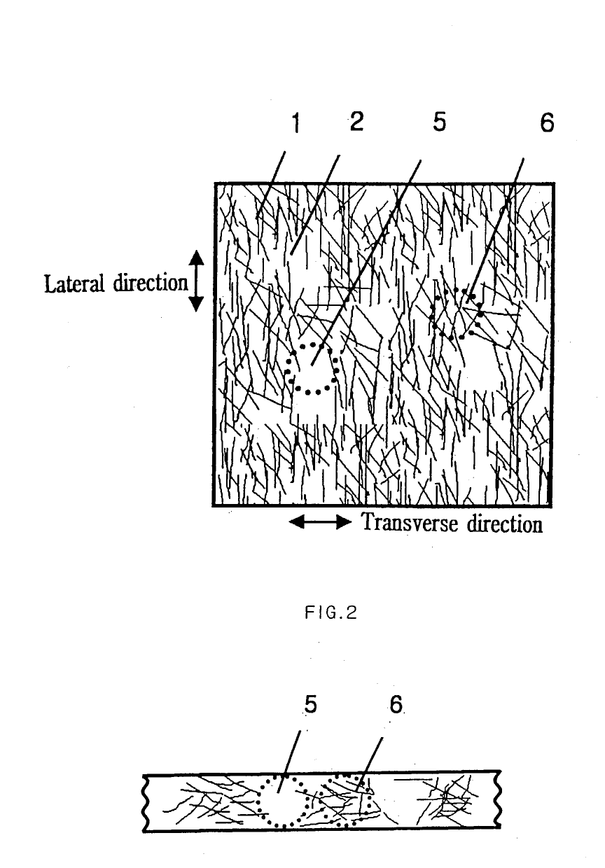

FIG. 1 and FIG. 2 show the plan view and cross-sectional view of the carbon fiber-embedded heating paper constituting the invention, respectively. In the said carbon fiber-embedded heating paper, carbon fibers(l) of 5-50 μm diameter and 0.5-20 mm length have been dispersed in the pulp(2) with some preferred alignment along the longitudinal direction of the said heating paper.

For the said carbon fiber-embedded heating paper, pulp rather than polymers is used as base material to disperse the carbon fibers. Contrary to polymers such as fluorocarbons, polyester, polyethylene, PVC, and polypropylene that are softened at elevated temperatures, pulp is not softened. Thus, the sheet heater using the pulp as base material to disperse the carbon fibers can be used at higher temperatures, compared with the sheet heaters for which polymers are used as base materials. Also, the paper composed of the pulp has higher strength than those of polymers.

Carbon fibers are used as conducting fillers of the heating paper in the presenting invention. Compared to carbon black powders of spherical shape, carbon fibers with the length much longer than the diameter can make easy contact each other when dispersed in the pulp. Thus, the amount of the carbon fibers dispersed in the pulp can be varied in a large range, which renders easy fabrication of the carbon fiber-embedded heating papers with different heating characteristics.

The sheet resistivity of the said carbon fiber-embedded heating paper is dependent upon the carbon fiber(1) to pulp (2) ratio in the heating paper and also dependent upon the thickness of the heating paper. As an example of the presenting invention, the sheet resistivity along the lateral direction of the heating paper could be adjusted to be 2-1200 Ω/□ by controlling the amount of the carbon fibers for the 40 μ m-thick heating paper.

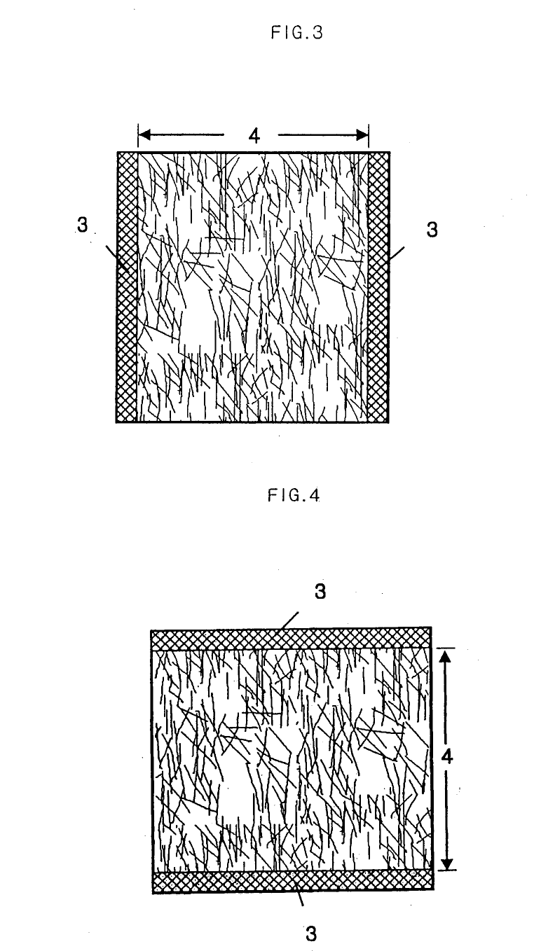

FIG. 3 illustrates the plan view of the carbon fiber-embedded heating paper where electrodes(3) are installed in the lateral edges of the heating paper to apply the voltage to the heating paper, and FIG. 4 shows the plan view of the carbon fiber-embedded heating paper with electrodes(3) installed in the transverse edges of the heating paper.

The heating characteristics of the said heating paper are dependent upon the sheet resistivity of the heating paper, the distance(4) between the electrodes(3) and the voltage applied to the electrodes(3). Heating papers with different heating characteristics are required in order to make various sheet heaters with different heating characteristics, which can be done by adjusting the content of the carbon fibers in the heating paper, the distance(4) between the electrodes(3), and the voltage applied to the electrodes(3).

Even without changing the distance between the electrodes(3) and the voltage applied to the electrodes(3), however, fabrication of the sheet heaters with different heating characteristics are possible with the same heating paper by controlling the alignment of the carbon fibers in the heating paper as the present invention. Controlling the alignment of the carbon fibers in the heating paper makes the sheet resistivity along the lateral direction of the heating paper different from the sheet resistivity along the transverse direction of the same heating paper.

For the heating paper where the alignment of the carbon fibers are controlled as in the present invention, carbon fibers have more contacts with each other in the lateral direction compared to the transverse direction. Thus, the sheet resistivity of the heating paper along the lateral direction becomes lower than the value in the transverse direction, resulting in higher heating capacity in the lateral direction. With increasing the degree of alignment of the carbon fibers, the sheet resistivity of the heating paper along the lateral direction becomes lower with increase in the sheet resistivity along the transverse direction, which makes the difference of the heating capacity along the longitudinal direction and transverse direction larger.

As an example of the present invention, the ratio of the sheet resistivity along the transverse direction to the sheet resistivity along the lateral direction can be changed within a range of 1.1-3.5 by controlling the degree of the alignment of the carbon fibers. The sheet resistivities of three heating papers along the lateral direction, examined for examples for the present invention, were 148.0 Ω/□, 60.4 Ω/□, and 13.5 Ω/□, when the sheet resistivity ratio of the transverse/lateral direction was 3.5.

The sheet heater is normally fabricated using the heating characteristics of the said heating paper along one direction either lateral or transverse. For some other applications where different heating characteristics are required, however, it is possible to fabricate the sheet heater of different heating capacity just by using the heating characteristics of the normal direction of the same heating paper. Referred to this invention, thus, the sheet heaters with different heating characteristics can be made easily with the same heating paper where the alignment of the carbon fibers is controlled to give different heating characteristics to lateral and transverse directions of the said heating paper.

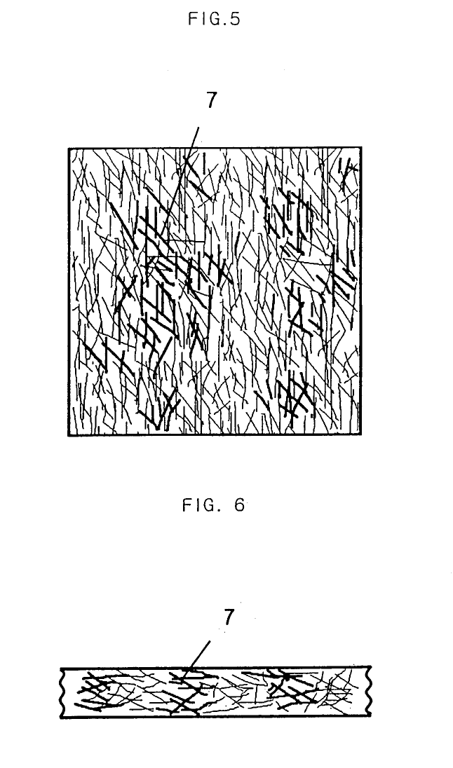

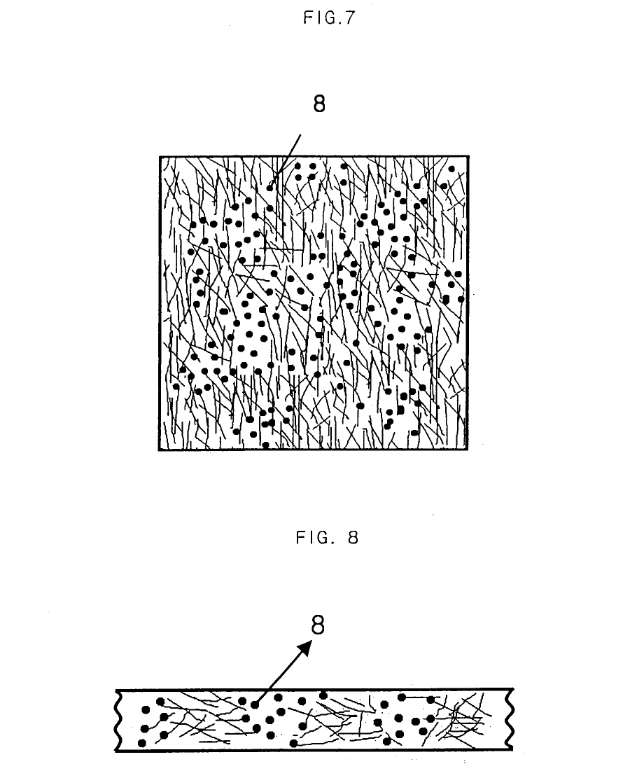

FIG. 5, FIG. 6, FIG. 7, and FIG. 8 show another embodiment of the present invention for the carbon fiber-embedded heating paper where ceramic fibers of high heat conductivity are dispersed with the carbon fibers.

In microscopic scale, dispersion of carbon fibers may not be uniform in the said carbon fiber-embedded heating paper, as exaggerated in FIG. 1. For a sheet heater fabricated using the carbon fiber-embedded heating paper, heat is generated by Joule heating of the carbon fibers, as the current passes only through the carbon fibers of the said heating paper. Thus, the temperature at the region of high carbon-fiber content goes much higher than the temperature at the region of low carbon-fiber content, when voltage is applied to the said heating paper. To fabricate a sheet heater using the said carbon fiber-embedded heating paper, polymer coatings are laminated on both surfaces of the said heating paper for electrical insulation. Such polymer coatings laminated to the said heating paper expand when temperature goes up by applying voltage to the said heating paper. Thus, the polymer coatings, laminated at the region of high carbon-fiber content, are to expand more than the polymer coatings laminated at the region of low carbon-fiber content. However, expansion of the polymer coating, laminated at the region of high carbon-fiber content, is inhibited by the nearby polymer coating of the lower temperature region with low carbon-fiber content. This builds up a compressive stress to the polymer coatings laminated at the area of high carbon-fiber content, which may cause delamination of the polymer coating from the said heating paper. Then, dielectric breakdown may occur at the delaminated area, causing detrimental effects on the reliability of the said sheet heater.

FIG. 5 to FIG. 8 illustrate another embodiments of the present invention to solve such problem caused by the microscopic temperature inhomogeneity of the heating paper. In FIG. 5 and FIG. 7, ceramic fibers(7) and ceramic powders(8) of high heat conductivity such as AlN, SiC, Si, and BN are dispersed together with carbon fibers to make the heating paper. Then, the heat generated at the region of high carbon fiber content can be conducted by such ceramic fibers(7) and ceramic powders(8) of high heat conductivity to the low temperature region of low carbon fiber content, resulting in temperature homogeneity of the whole sheet heater even in the microscopic scale.

Heat conductivity of the pulp(2) used to make the said heating paper is below 1.0 W/m-K. Compared to low heat conductivity of the pulp, heat conductivities of AlN, SiC, Si, and BN are much higher as 230 W/m-K, 270 W/m-K, 84 W/m-K, 600 W/m-K, respectively. With dispersing such ceramic fibers, ceramic powders, or their mixture in the heating paper, thus, the heat generated at the region of high carbon fiber content in the heating paper can be efficiently distributed to the region of low carbon fiber content of the same heating paper.

Considering homogeneous dispersion of the said heat-conducting ceramic fibers(7) in the pulp, the most suitable sizes of the heat-conducting ceramic fibers(7) in the present invention are the same as those of the carbon fibers (5-50 μm diameter and 0.5-20 mm length). However, the heat-conducting ceramic fibers of which sizes are not in these ranges are also applicable in the present invention. Considering homogeneous dispersion of the said heat-conducting ceramic powders(8) in the pulp, the most suitable sizes of the heat-conducting ceramic powders(8) in the present invention are below 1 μm. However, heat-conducting ceramic powders larger than 1 μm are also applicable in the present invention.

In the present invention, ceramic fibers and powders of AlN, SiC, Si, and BN are mentioned as examples of the heat-conducting media to be dispersed with carbon fibers. However, other ceramics fibers, powders, and their mixture can be applicable in the present invention when such materials or mixture of materials have heat conductivity higher than the value of the pulp in the heating paper.

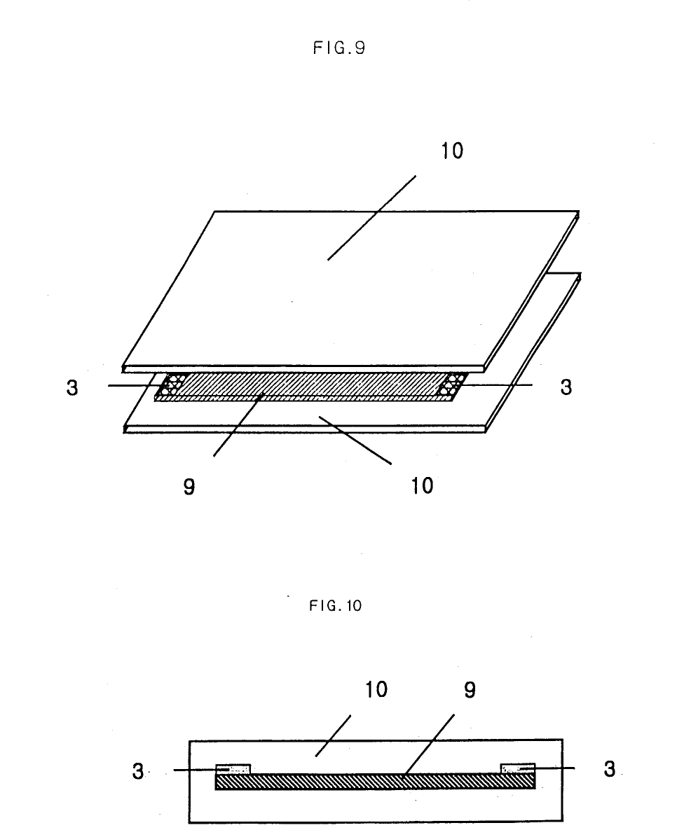

FIG. 9 and FIG. 10 illustrate the sheet heater of the present invention. The sheet heater has polymer coatings(10) laminated for electrical insulation on each surface of the said heating paper(9) where at least one pair of electrodes(3) are installed on the lateral or transverse edges. The sheet heater in FIG. 9 and FIG. 10 illustrates one layer of polymer coating(10) laminated on each surface of the heating paper. Depending on the applications, however, more than two layers of different polymer coatings can be laminated to make the said sheet heater.

As materials for the polymer coating of the said sheet heater, polyester, acryl, ABS, cellulose, fluorocarbons, polyethylene, polypropylene, polystyrene, rubber, polyvinylchloride(PVC), polyvinylfloride, polyamide, polyimide, polyuretane, epoxy, epoxy/fiberglass fabric, and so on.

Heat conductivities of the above-mentioned polymers are as low as 0.1-0.4 W/m-K. Thus, the heat generated at the heating paper of the sheet heater may not be easily released outward through the polymer coatings due to their low thermal conductivities, decreasing the heating efficiency of the said sheet heater. Even worse, heat may be accumulated at the interface between the heating paper(9) and polymer coating(10), causing the failure of the sheet heater due to the delamination at the interface between the heating paper(9) and polymer coating(10).

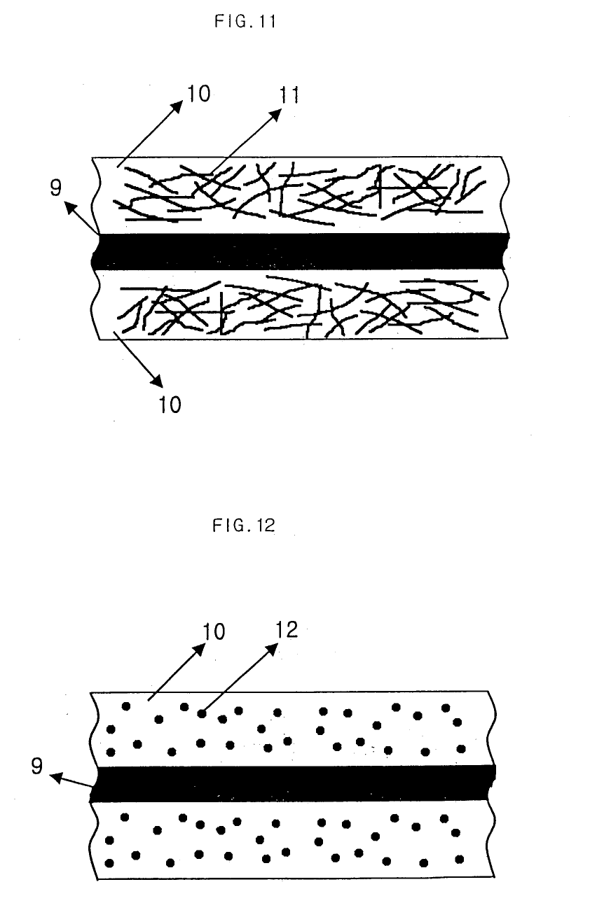

FIG. 11 illustrates the embodiment of the present invention for which ceramic fibers are dispersed as heat-conducting media in the polymer coatings of the said sheet heater. FIG. 12 also shows another embodiment of the present invention for which ceramic powders are dispersed as heat-conducting media in the polymer coatings of the said sheet heater.

The heat conductivity of the polymer coatings(10) can be improved by dispersing ceramic fibers(11) and/or ceramic powders(12) of high heat conductivity such as AlN, SiC, Si, and BN homogeneously in the polymer coatings(10), resulting in the substantial improvement in the heating efficiency of the sheet heater. Also the long-term reliability of the sheet heater can be acquired by preventing the failure due to the above-mentioned interfacial delamination. Compared to the low heat conductivity of the polymer coatings, heat conductivities of AlN, SiC, Si, and BN are much higher as 230 W/m-K, 270 W/m-K, 84 W/m-K, 600 W/m-K, respectively.

Considering homogeneous dispersion of the said heat-conducting ceramic fibers(7) in the polymer(9), the most suitable sizes of the heat-conducting ceramic fibers(7) in the present invention are about 5-50 μm diameter and 0.5-20 mm length. However, the heat-conducting ceramic fibers of which sizes are not in these ranges are also applicable in the present invention. Considering homogeneous dispersion of the said heat-conducting ceramic powders(8) in the polymer, the most suitable sizes of the heat-conducting ceramic powders(8) in the present invention are below 1 μm. However, heat-conducting ceramic powders larger than 1 μm are also applicable in the present invention.

In the present invention, ceramic fibers and powders of AlN, SiC, Si, and BN, and the combined mixtures of these fibers and powders are mentioned as examples of the heat-conducting media to be dispersed in the polymer coatings. However, other ceramics fibers and powders, and their mixture can be applicable in the present invention when such materials or mixtures have heat conductivity higher than the value of the polymer coating(10).

As results of the present invention, sheet heaters with different heating characteristics can be easily fabricated with the same heating paper composed of the carbon fiber-embedded heating paper in which the alignment of the carbon fibers is controlled to give different heating characteristics to lateral and transverse directions of the said heating paper. Also, the heating characteristics and reliability of the sheet heater can be improved by dispersing heat-conductive ceramic fibers, powders and their mixture together with the carbon fibers in the pulp. In addition, the heating efficiency and long-term reliability of the sheet heater can be improved by dispersing heat-conductive ceramic fibers and powders in the polymer coatings laminated on the heating paper.

What is claimed is:

1. Deleted

2. Deleted

3. A carbon fiber-embedded heating paper of claim 1, where heat-conducting ceramic fibers(7), ceramic powders(8), or their mixture are dispersed as heat-conducting media together with carbon fibers for temperature homogeneity.

4. A sheet heater of claim 3, which is consisted of the carbon fiber-embedded heating paper of claim 3.

5. A sheet heater of claim 3, where heat-conducting ceramic. fibers(7), ceramic powders(8), or their mixture are dispersed as heat-conducting media in the polymer coating(10).

6. A sheet heater of claim 3, where heat-conducting ceramic fibers(7), ceramic powders(8), or their mixture are dispersed as heat-conducting media both in the carbon fiber-embedding heating paper and polymer coating(10).
